(19) United States
(12) Patent Application Publication
(10) Pub. No.: US 2004/0117240 A1
(43) Pub. Date: Jun. 17, 2004

(54) Environmental performance assessment

(76) Inventors: James Neil Ness, Brisbane (AU); Terence Peter De Lacy, Highgate Hill (AU); John Ashley Scott, Windsor, CA (US); Graeme Leonard Worboys, Gilmore (AU)

Correspondence Address: TUCKER, ELLIS & WEST LLP, 1150 HUNTINGTON BUILDING, 925 EUCLID AVENUE, CLEVELAND, OH, 44115-1475, US

(21) Appl. No.: 10/468,668

(22) PCT Filed: Feb. 19, 2002
(86) PCT No.: PCT/AU02/00173

(30) Foreign Application Priority Data
Jan. 20, 2001 (AU) PR 3198

(51) Int. Cl. G06F 17/60

(52) U.S. Cl. 705/10

(57) ABSTRACT

The present invention provides a method of assessing the sustainability performance of an entity. This is achieved by monitoring the operation of the entity, and using this to determine one or more sustainability indicators, each sustainability indicator being a respective value determined based on the operation of the entity. The sustainability indicators are then compared to respective thresholds allowing the sustainability performance to be determined in accordance with the results of the comparison.

### BACKGROUND OF THE INVENTION

The present invention relates to a method of assessing the sustainability performance of an entity, and in particular, to a method of certifying entities that attain predetermined sustainability standards.

### DESCRIPTION OF THE PRIOR ART

The reference to any prior art in this specification is not, and should not be taken as, an acknowledgement or any form of suggestion that the prior art forms part of the common general knowledge in Australia.

In recent years there has been a move by many companies to improve their environmental and sustainable policies, thereby making the companies more responsible. The driving force behind this is the realisation that many consumers are willing to sacrifice cost savings when purchasing products or services that they perceive to be more environmentally responsible.

Thus, for example, market surveys in the US have shown that on average, US citizens will pay an additional $19.00 per person for holidays at environmentally friendly locations than other normal locations.

Accordingly, appreciating this companies have been attempting to make themselves more responsible, for example by changing operation procedures to reduce energy and water consumption, and to produce less waste.

A major problem with this however is that there is currently no simple way of determining how environmentally friendly an entity, such as a company is. In particular, whilst the company may assert that they are environmentally friendly, the consumer themselves have very little evidence of this, and therefore have to rely on trusting the company.

This situation is detrimental to both customers and companies themselves. In particular, customers can be lead into believing that companies are more responsible than is actually the case. Similarly, companies that make a large effort to improve their environmental policy have no way of demonstrating this fact absolutely to the customers. This leads to the situation where customers who are willing to pay additional funds for environmentally friendly products and services are unable to judge which products and services fulfil their requirements. This in turn will reduce the benefit of being responsible to the companies, thereby preventing a wide scale move to environmentally friendly policies.

### SUMMARY OF THE PRESENT INVENTION

In a first broad form the present invention provides a method of assessing the sustainability performance of an entity, the method including:

a) Monitoring the operation of the entity;

b) Determining one or more sustainability indicators, each sustainability indicator being a respective value determined based on the operation of the entity;

c) Comparing one or more of the sustainability indicators to respective thresholds; and,

d) Generating an indication of the sustainability performance in accordance with the results of the comparison.

The sustainability indicators generally include at least one of:

a) An energy indicator representing the amount of energy used by the entity;

b) A water indicator representing the amount of water used by the entity; and,

c) A waste indicator representing the amount of waste generated by the entity.

Other indicators can alternatively be used, and in general the indicators used will depend on the nature of the entity being assessed.

Typically at least one of the sustainability indicators includes one or more component values, the sustainability indicator being determined based on a weighted sum of the component values. This is however not essential, and some indicators may be calculated directly, for example by measurement, or from utility bills, or the like.

Thus, for example, the energy indicator can be formed from one or more energy component values, each energy component value representing the amount of energy used from a respective energy source.

In this case, the method of determining the energy indicator typically includes:

a) Determining a respective energy component based on the amount of energy used from a respective source;

b) Multiplying each energy component by a respective parameter to determine a respective modified component, each parameter being predetermined in accordance with the respective energy source; and,

c) Summing each of the modified energy components.

The sustainability indicators may also include at least one of:

a) A social commitment indicator representing the impact of the entity on the local community;

b) A resource conservation indicator representing the amount of ecological products used; and,

c) A pollution indicator representing the amount of pollution to air, water and land.

In this case, the social commitment indicator may be a ratio of the number of employees living within a predetermined distance of the entity to the total number of employees. Alternatively, the social commitment indicator might be the amount of goods purchased locally as a percentage of total goods purchased. The resource conservation indicator is generally a ratio of the number of ecolabel products used to the total number of products used, while the pollution indicator might be a ratio of the amount of biodegradable chemicals used to the amount of non-biodegradable chemicals used.

The sustainability indicators may also require at least the presence and implementation of a sustainability policy.

Typically, in response to a successful comparison, the method further includes:

a) Comparing one or more of the sustainability indicators to respective second thresholds; and,

b) Generating a further indication of the sustainability performance in accordance with the results of the second comparison.

The method usually includes:

a) Comparing each indicator to a respective threshold; and,

b) Determining that the entity satisfies minimum requirements in response to a successful comparison for each indicator.

Typically each sustainability indicator is normalised relative to the size of the operation. Thus the sustainability indicators are typically calculated as either a ratio or per unit value, such as per guest at a hotel.

In this case, the method preferably includes:

a) Comparing each indicator to a normalised curve for this indicator; and,

b) Recommending improvements for each indicator in terms of this normalised curve.

The method preferably further includes certifying the entity in response to a successful determination.

Thus, the entity typically has to satisfy a number of comparisons before it is determined that the entity satisfies minimum sustainability requirements, thereby qualifying for certification. However, alternatively, each comparison could be assessed independently, so that separate certification is based on each comparison. Alternatively, the indicator values could be combined and the assessment performed on the basis of a single threshold comparison.

Typically the method includes:

a) Comparing each indicator to a respective second threshold; and,

b) Determining that the entity satisfies best practice requirements in response to a successful second comparison for each indicator.

This allows different levels of certification to be provided. It will be appreciated that any number of levels of certification may be provided as desired.

Each threshold is typically determined in accordance with at least one of:

a) The entity's location; and,

b) The nature of the entity's operation.

This allows the certification to take into account environmental factors that are location or industry specific. For example the impact of electricity generation on the environment will differ depending on how the electricity is generated. Accordingly, the effect of using electricity from the National Grid will vary depending on the entity's location. The effect of this can be handled by setting thresholds based on factors, such as the location or nature of the entity.

Each threshold may be determined in accordance with an average of the respective sustainability indicators determined for a sample number of entities, although other techniques, such as studying environmental reports, building environmental impact studies, recommendations from government or other organisations or the like.

In the case in which averages are used, the threshold can be set 5% higher than the average of the respective sustainability indicators. This allows the system to ensure that the entity must be above average to get the minimum level of certification. In this case, the second threshold can be 30% higher than the average of the respective sustainability indicators, for example.

The entity or a member of the entity may perform the monitoring. Alternatively, an accredited individual could perform the monitoring. However, generally a mixture of the two would be used, allowing for example, the member of the entity to do the initial assessment, with the accredited individual monitoring in future years.

Typically the method further includes generating a report, the report indicating the sustainability performance of the entity by indicating at least the results of the comparisons.

The report may also further indicate improvements that could be made to the operation to thereby the sustainability performance of the entity.

Typically the method is performed using a processing system including at least:

a) An input for receiving the one or more sustainability indicators;

b) A store for storing the respective thresholds; and,

c) A processor, the processor being adapted to:

i) Compare the one or more of the sustainability indicators to respective thresholds; and,

ii) Generate the indication of the sustainability performance in accordance with the results of the comparison.

In this case, the method typically further includes causing the processor to store entity data in the store, the entity data representing at least:

a) The identity of the entity; and,

b) The sustainability indicators.

The entity data may also further represent at least:

c) The location of the entity; and,

d) The nature of the entity's operation.

The method can then include determining the thresholds in accordance with the entity data stored in the store.

In a second broad form the present invention provides a system for assessing the sustainability performance of an entity, the system including:

a) An input for receiving one or more sustainability indicators, each sustainability indicator being a respective value determined based on the operation of the entity;

b) A store for storing respective thresholds; and,

c) A processor, the processor being adapted to:

i) Compare the one or more of the sustainability indicators to the respective thresholds; and,

ii) Generate the indication of the sustainability performance in accordance with the results of the comparison.

In this case, the input can be formed from a remote processing system coupled to the system via a communications network, although other forms of input could also be used.

The system can also be formed from a number of interconnected processing systems.

Typically the system is adapted to perform the method of the first broad form of the invention.

In a third broad form the present invention provides a computer program product for assessing the sustainability performance of an entity, the computer program product including computer executable code which when executed by a suitably programmed processor causes the processor to perform the method of the first broad form of the invention.

### BRIEF DESCRIPTION OF THE DRAWINGS

An example of the present invention will now be described with reference to the accompanying drawings, in which:

FIG. 1 is a schematic diagram of an example of a system for implementing the present invention;

FIG. 2 is a schematic diagram of an example of one of the processing system of FIG. 1;

FIG. 3 is a schematic diagram of an example of one of the end stations of FIG. 1;

FIG. 4 is a flow chart of an overview of the process of obtaining certification using the system of FIG. 1; and,

FIG. 5 is a flow chart of an example of the process of obtaining certification for an entity in the tourist accommodation industry, using the system of FIG. 1.

### DETAILED DESCRIPTION OF THE PREFERRED EMBODIMENTS

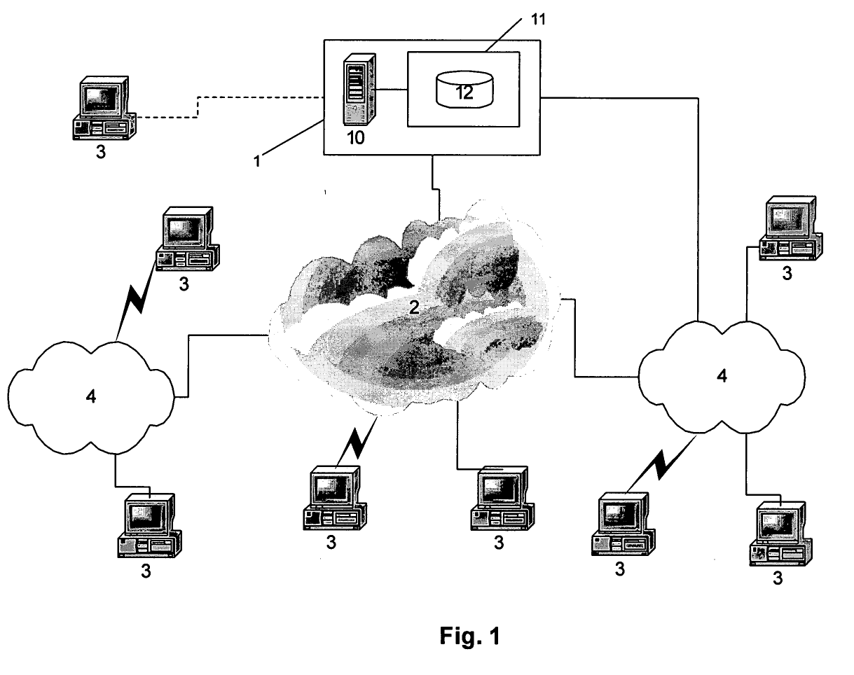

An example of the present invention will now be described with reference to FIG. 1, which shows a system suitable for implementing the present invention.

As shown, the system includes a base station 1 coupled to a number of end stations 3, via a communications network 2, and/or via a number of local area networks (LANs) 4. The base station 1 is generally formed from one or more processing systems 10 coupled to a data store 11, the data store 11 usually including a database 12, as shown.

In use, users of the end stations 3 can access services provided by the base station 1. These services generally include allowing entities, such as companies or individuals, to obtain environmental certification, to obtain information relating to certification and improving environmental procedures, as well as allowing third parties to access details of certified entities.

The system may be implemented using a number of different architectures. Thus, in one example, the communications network 2 is the Internet, with the LANs 4 representing private LANs, such internal LANs within a company or the like. In this case, the services provided by the base station 1 are generally made accessible via the Internet 2, and accordingly, the processing systems 10 may be capable of generating web-pages or like that can be viewed by the users of the end stations 3.

Alternatively, information can be transferred between the end station 3 and the base station 1 using other techniques as represented by the dotted line. These other techniques may include transferring data in a hard, or printed format, as well as transferring the data electronically on a physical medium, such as a floppy disk, CD-ROM, or the like, as will be explained in more detail below.

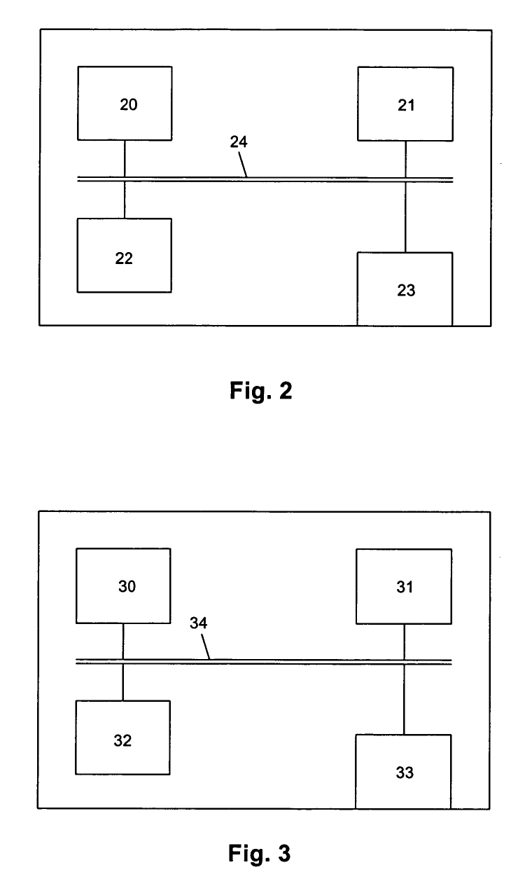

In any event, the processing systems 10 may be any form of processing system but typically includes a processor 20, a memory 21, an input/output (I/O) device 22 and an interface 23 coupled together via a bus 24, as shown in FIG. 2. The interface 23, which may be a network interface card, or the like, is used to couple the processing system to the Internet 2.

It will therefore be appreciated that the processing system 10 may be formed from any suitable processing system, which is capable of operating applications software to enable the provision of services. However, in general the processing system 10 will be formed from a server, such as a network server, web-server, or the like.

The end stations 3 must generally be capable of receiving and processing data, as well as transferring data to the base station 1 in some cases. Accordingly, in this example, as shown in FIG. 3, the end station 3 is formed from a processing system including a processor 30, a memory 31, an input/output (I/O) device 32 and an interface 33 coupled together via a bus 34. The interface 33, which may be a network interface card, or the like, is used to couple the end station 3 to the Internet 2.

It will be therefore be appreciated that the end station 3 may be formed from any suitable processing system, such as a suitably programmed PC, Internet terminal, lap-top, hand-held PC, or the like. The end station 3 may also operate applications software to enable web-browsing or the like.

Alternatively, the end station 3 may be formed from specialised hardware, such as an electronic touch sensitive screen coupled to a suitable processor and memory. In addition to this, the end station 3 may be adapted to connect to the Internet 2, or the LANs 4 via wired or wireless connections. It is also feasible to provide a direct connection between the base stations 1 and the end stations 3, for example if the system is implemented as a peer-2-peer network.

In use, the system allows users of the end stations 3 to attempt to obtain environmental certification from the base station 1. The certification may be obtained for one or a group of companies, individuals, service providers, or the like (hereinafter referred to generally as an entity).

Overview

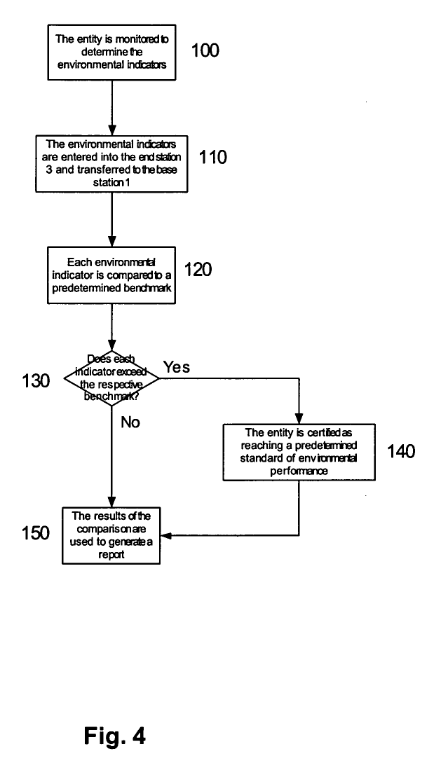

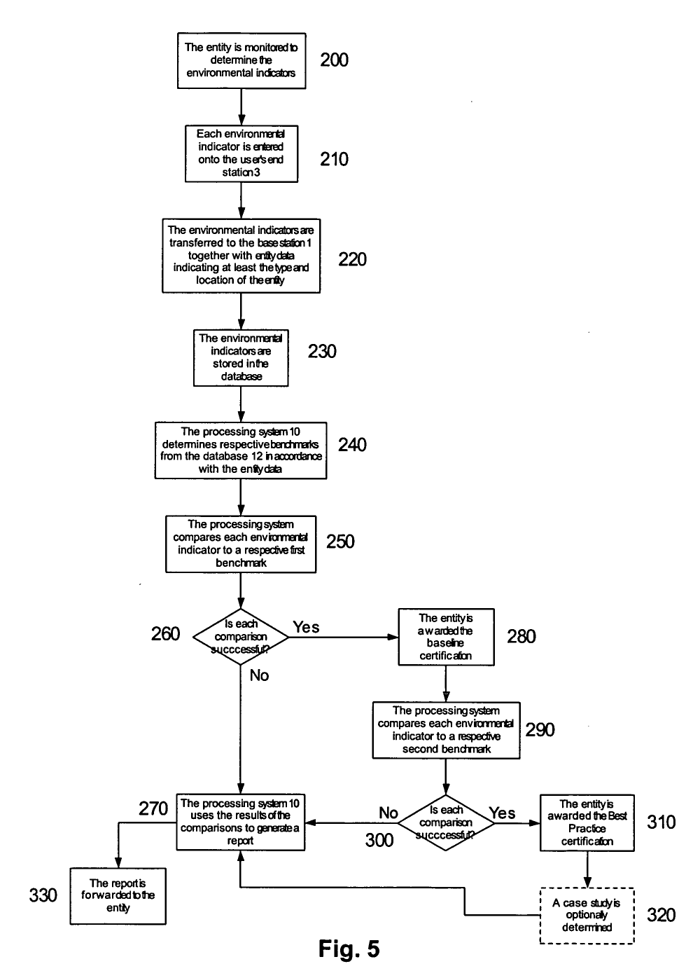

An overview of the process will now be described with reference to FIG. 4.

As shown at step 100, the first stage is for the entity to be monitored to determine a number of sustainability indicators. The sustainability indicators are a measure of the operation of the entity in a particular environmental area.

Thus for example, the sustainability indicators may include an indication of the amount of energy, such as electricity, consumed, or the amount of water consumed by the entity. Examples of sustainability indicators are shown in Appendix A.

In general, the sustainability indicators can be determined relatively easily. Thus for example, in the case of the water consumed, this can simply be measured from a water meter. In the case of determining the amount of energy consumed, the system allows users to provide information obtained from utility bills, outlining the amount of energy such as electricity, or gas, obtained from different sources. This is then added together to determine the corresponding sustainability indicator, as will be explained in more detail below.

The sustainability indicators are entered into or calculated using the end station 3, before being transferred to the base station 1 at step 110. As mentioned above, this can happen in anyone of a number of ways depending on the architecture of the implementing system.

Each sustainability indicator is then compared to a predetermined benchmark by the base station 1 at step 120. In general, the benchmark is intended to represent a minimum level of efficiency, or environmentally friendly operation that is required in order to obtain certification. As each sustainability indicator is independent, it is generally necessary to provide a distinct benchmark to correspond to each sustainability indicator.

However, in addition to this, the environmental impact of an entity's operation may vary depending on the region in which the entity is located. Thus for example, in a region where fresh water is readily available, the effects of water consumption will not have such a great impact on the environment as in regions where fresh water is typically scarce. Accordingly, the predetermined benchmarks may also be location specific.

Furthermore, it will be appreciated that different industries will require different benchmarks. In particular, it will be readily apparent that a chemical processing plant will typically require more energy and water than for example a hotel. Accordingly, the benchmarks may be set according to both the entity's type and location.

In any event, once each sustainability indicator has been compared to a respective benchmark at step 130, it is determined whether each indicator exceeds the respective benchmark. If this is the case, the entity is certified as reaching a predetermined standard of sustainability performance at step 140. Otherwise, certification is not granted.

In any event, whether certification is granted or not the results of the comparison are used to generate a report at step 150. This report can then be used by the entity to improve their sustainability performance subsequently.

### DETAILED DESCRIPTION OF A SPECIFIC EXAMPLE

A detailed description of the operation of the system of FIG. 1 will now be described. In this example, the entity will be taken to be involved in the tourist accommodation industry.

As shown at step 200, the first stage in the process is for the entity to be monitored to determine the sustainability indicators. The sustainability indicators used in this particular example, together with examples of additional sustainability indicators used in other industries are shown in appendix A.

Thus, in the tourist accommodation industry it is necessary for the respective entity to generate sustainability indicators indicating:

The presence of a sustainable environmental policy;

Energy consumption;

Potable water consumption;

Solid waste production;

Social commitment;

Resource conservation;

Cleaning chemicals used;

One optional indicator chosen from list; and,

One agreed indicator nominated by entity operator.

The exact manner in which each sustainability indicator is calculated will depend on the nature of the indicator itself. However, in general the sustainability indicators are determined by measuring the absolute usage for the entity and then normalising this value, such that the values for different sized entities may be directly compared to the same benchmark, as will be described in more detail below.

Thus, for example, in the case of water consumption, the indicator requires the calculation of the water consumed per guest night or per roof area. This can easily be calculated by determining the total amount of water used during a predetermined time period for the entire entity. This value is then normalised by dividing by the number of guests staying per night, or the total roof area, as appropriate.

Similarly, the solid waste production indicator has the calculation of the volume of waste per guest night or per area under roof. Again, this will require that the amount of solid waste produced be measured. The social commitment indicator involves determining the number of employees living within twenty kilometres and setting this as a ratio with respect of the total number of employees. The resource conservation indicator is an indication of the ratio of Ecolabel products purchased and normal products purchased, whilst the cleaning chemicals used is an indication of the ratio of the biodegradable chemicals to normal chemicals used.

The only major variations on this are the presence of a sustainable environment policy indictor, which is a yes/no indication of whether an environmental policy is in place, and the energy consumption indictor.

The energy consumption indicator is generally formed from a sum of component values, with each component value representing the energy obtained from a respective source. The reason for this is that energy generated from different sources will generally be in different units.

In order to calculate the energy consumption indicator, the user provides the component values to applications software executed by the end station 3. The applications software multiplies each entered component value by a respective parameter to ensure that each of the component values are converted into the same energy unit. These modified components are then added to calculate a total value, which is then normalised to determine the energy consumption indicator.

The parameters used are based on the calorific values of the various fuels and on the different units used to measure energy or amount of fuel consumed.

The applications software can also be adapted to use the energy component values to determine the environmental impact caused as a result of the entity's energy consumption, such as for example, to determine the amount of carbon dioxide generated.

In this case, the calculation would again sum the component values after they have multiplied by a respective parameter. In this instance however, the environmental impact will depend not only on the amount of energy used, but also on the manner in which it is generated. Accordingly, the parameters are determined based on the environmental impact of the manner in which the energy is generated.

Thus, for example, energy obtained from the national grid will typically come from exhaustible energy supplies, such as oil, coal or natural gas. As this form of energy generation typically has a large environment impact, for example by generating large amounts of CO₂, the parameter will generally have a high value. In contrast, electricity obtained for example from solar power has a lower environment impact, for example as it generates less CO₂, and will therefore have a much lower parameter.

Once all the sustainability indicators have been determined these are then entered onto the user's end station 3 at step 210. The sustainability indicators are transferred to the base station 1 at step 220, together with entity data indicating at least the nature and location of the entity. In the current example of tourist accommodation, the entity data would indicate tourist accommodation and the address at which the accommodation was located.

The manner in which the data is transferred from the end station 3 to the base station 1 can vary. For example, the end station 3 may be accessing a website generated by the end station 1. The website includes appropriate fields allowing the user to enter the data in their respective one of the fields, thereby transferring the data to the base station 1. Alternatively, the data could be transferred electronically in the form of an e-mail, or in the form of a file, transferred using an FTP or the like.

It is also possible for the user to transfer the information in a hard format, such as via fax, post or the like. This could be achieved by causing the end station 3 to print out each sustainability indicator together with the entity data on a sheet of paper which can then be forwarded to the base station 1 for manual input.

Once the base station 1 has received the sustainability indicators and the entity data, these are typically stored in the database 12 at step 230 for future reference, as will be described in more detail below.

In any event, at step 230 the processing system 10 operates to determine appropriate benchmarks from the database 12 in accordance with the entity data. As mentioned above the benchmarks used will depend on both the location and the nature of the entity. Accordingly, the database 12 will typically store a lookup table (LUT) which indicates for each type of entity and each entity location the respective benchmarks that should be used.

At step 240 the processing system 10 compares each sustainability indicator to a respective first benchmark.

The first benchmark generally indicates the minimum value of sustainability indicator that is acceptable. Thus, if the value of the environment locator exceeds the benchmark, this indicates that the environment policy in this particular area is unacceptable. Thus for example, if the energy exceeds a predetermined value, this indicates that the entity is using more energy than is environmentally desirable. Accordingly, in this instance the comparison would fail.

At step 260 the processing system 10 determines if each comparison is successful. If not the processing system 10 uses the results to generate a report at step 270. An example report for this example is shown in Appendix C.

Otherwise the processor moves on to step 280 and indicates that the entity has been awarded base line certification.

The processing system 10 then moves on to step 290 to compare each sustainability indicator to a respective second benchmark. The second benchmark defines stricter criteria then the first benchmark. Thus, for example, the second benchmark requires that the entity uses even less water per guest night in order for a successful comparison to be obtained.

Again, the processor determines at step 300 whether each comparison has been successful. If not, the processor proceeds to step 270 to generate a report. However, if the each comparison is successful the processing system 10 moves on to step 310 to award the entity a best practice certification before issuing the report at step 270. The processing system 10 can optionally generate a case study at step 320 as will be described in more detail below.

Once generated the report is forwarded to the entity at step 330. As shown in Appendix C, the report will generally indicate the particular sustainability indicators that are determined for the entity, together with an indication of whether each sustainability indicator satisfies both the first and second benchmark values. In the event that any certification has been awarded, an indication of this will also be included in the report.

Benchmark Calculation

Benchmarks can be calculated in a number of different ways and this will typically depend on the nature of the benchmark itself.

Typically, for example, the benchmarks are calculated by taking into account a number of different environmental and social performance areas. These typically include areas such as greenhouse gas generation, energy management, air quality, fresh water resources, waste water management, waste minimisation, social and cultural impact, land use management, ecosystem conservation.

As shown in appendix B for example, the energy consumption will generally have an impact on a greenhouse gas production, energy management, air quality, waste minimisation and ecosystem conservation.

Accordingly, it is preferable for each of these respective areas to be taken into account when generating the benchmarks.

However, it is also possible to take into account additional information, such as environmental or governmental legislation. Similarly, in the case of holiday accommodation for example, certain building standards have also been issued which can be used in the calculation of the benchmarks.

Accordingly, the calculation of the benchmarks is to a large extent a subjective procedure that will require the constant review of existing environmental policies.

However, in addition to generating the benchmarks by considering the above factors it is also possible to generate the benchmarks based on the operation of other entities of an equivalent type and location.

An example of the manner in which this is achieved is to determine sustainability indicators for a large number of entities. The value of the determined sustainability indicators are then averaged with the first benchmark being set 5% offset to the average value. Thus, in order to gain a base line certification, a company must be operating with at least a 5% greater efficiency than average.

Similarly, the best practice certification can be based on at least a 30% higher efficiency than the determined average.

In this instance, when the system is initially configured the benchmarks will have to be determined manually for example by consideration of environmental factors. However, once a suitable number of entities have submitted sustainability indicators, this will allow averages to be generated which can then be used to either create new benchmarks or modify existing benchmarks.

Accordingly, it is advantageous for each of the sustainability indicators to be stored within the database 12. The processing system 10 can then monitor the number of sustainability indicators stored for a given entity type and location and then use this to generate an average when a suitable number is available.

Additional Features

A number of additional features are also available within the present invention.

Reports

The reports can be adapted to indicate improvements that have been achieved, either in comparison to previous years, or in comparison to the benchmarks. These improvements can be compared to a normalised curve to show the improvement relative to other entities.

The generated reports can be tailored to provide the entity with an indication as to areas in which their environmental policy could be improved. Thus for example, if the energy sustainability indicator is particularly high, the report could advise the entity to not only attempt to reduce the amount of energy used, but also to obtain more energy from environmentally friendly sources.

It will be appreciated that the comments produced may be produced manually by having an operative of the base station 1 examine each report and then provide appropriate comments. Alternatively however each comment could be a selected standard comment that is downloaded from the database 1 based on differences between the sustainability indicators and the benchmarks. Thus, for example, a large difference between the sustainability indicators and the benchmarks may indicate that a large amount of work is required by the entity. As a result, the processing system 10 could supply comments addressing the major forms of environmental policy that generally result in such poor performance.

As an alternative however the operatives of the base station 1 may actually visit the entity and perform a review of the entity's procedures to provide more tailored advice.

Auditing

The above description indicates merely that the sustainability indicators are determined by monitoring the entity. However, this could be performed either by the entity, or in the case of a company a member of the company, or by an operative of the base station 1. In the first scenario it is theoretically possible for the entity to manipulate the energy indicator values to ensure that at least base line certification is achieved, for example.

However, it will typically be difficult for an entity to manipulate figures successfully on a first attempt, primarily because they will be unaware of the benchmark values. However, having submitted sustainability indicators once, the entity may be able to guess approximate values for the benchmarks and thereby manipulate sustainability indicators in future years.

In order to avoid this, the entity can be provided with a certification for one year on the basis of sustainability indicators provided by the entity itself. In this instance, to maintain the certification after one year, the entity must submit to an audit in which an operative of the base station 1 will audit the entity and review how the sustainability indicators are determined.

The operative will perform a detailed review of the entity's operation and determine sustainability indicators based thereon, which are then applied to the method outlined above. This ensures that sustainability indicator values are not manipulated by the entity thereby allowing the system to ensure that the certification is only granted when certain levels of environmental procedures are virtually achieved.

It will be appreciated that the use of an audit can be repeated at predetermined intervals as required.

Costs

Significant cost savings can be achieved by improving the efficiency of a businesses operation, which often ties in well with improving the sustainability performance. Thus for example, a reduction in the energy consumption of a company can lead to significant cost savings.

Accordingly, the present invention can be adapted to provide the user with cost indications. Cost indications can be achieved using a look-up table that stores a base cost per unit for each sustainability indicator. The system can multiply each sustainability indicator by an appropriate base cost per unit, to estimate a respective cost for the entity. Thus, for example, in the case of the energy consumption indicator, the LUT will store an indication of the average cost of one unit of the environmental energy indicator and allow this to calculate a total cost of obtaining the energy for the entity.

The entity can then be provided with evaluations, such as the reduction in costs that would be obtained if the entity were to meet either the first or second benchmarks.

In addition to this, once the entity has submitted sustainability indicators over at least two years, the system can be adapted to estimate the cost saving that has been achieved by any improvements in sustainability performance from year to year.

Case Study

In order to encourage other entities to participate in the scheme, when an entity obtains a best practice certification, the base station 1 can operate to generate a case study outlining how this has been achieved.

In particular, an operative of the base station 1 will visit the entity and assess which factors have had a major impact on obtaining the improved sustainability performance, as well as any impact this may have had on costs, or the like.

The case study can then be published by the base station 1, for example as a web page, allowing users of the end stations 3 to access the case study and view the facts of the environmental improvement.

Certification Search

The base station 1 will typically publish a list of all entities involved in the project that have achieved at least base line or best practice certification. Details of these entities will be searchable in accordance with the entity type and location, allowing consumers such as holidaymakers or the like to perform searches to locate entities that have satisfied the predetermined environmental requirements. This allows the consumers to be certain that the products and services they are obtaining come from environmentally friendly sources.

Architecture

The present invention can be implemented using a number of different architectures. The architecture described above with respect to FIG. 1 is particularly advantageous for a number of reasons.

Firstly, the benchmarks are stored centrally on the database 12. Accordingly, as benchmarks are updated, these only need to be updated at the central location 12.

Similarly, the sustainability indicators for each entity are stored centrally at the database 12. This allows benchmarks to be calculated in the manner described above. In addition to this, it allows the sustainability indicators obtained over previous years to be compared to current sustainability indicators thereby determining if improvements in performance have been obtained.

Finally, this form of configuration allows the environmental data and entity data of different companies to be retained secret whilst still allowing the data to be used by the base station 1 in calculations, such as determining benchmarks. This allows the benchmarks to be retained secret, thereby avoiding the situation in which entities attempt to manipulate figures to thereby ensure they achieve certification.

However, this is not essential for operation of the present invention. Accordingly for example, each end station could be provided with application software that includes an indication of the benchmarks.

In this case, it would not be necessary to actually use the base station 1 at all. Instead, each entity could simply enter data using their appropriate application software to allow the sustainability indicators to be compared to their respective benchmarks, on the end station 3 itself. This would thereby obviate the need for the base station 1.

However, it will be appreciated that the certification could not be controlled in this instance. Accordingly, the end station 3 could be adapted to generate an indication of whether the comparisons were successful and certification has been achieved. In this case, an indication that certification has been achieved could be transferred to a base station 1 allowing the certification to be controlled centrally.

In this case however there is a risk that the benchmarks would become public information in order to avoid this, it would generally be necessary to ensure that the benchmarks are stored in an encrypted fashion on the end station 3. Furthermore, the transfer indication of certification would also have to be transferred in an encrypted manner to prevent individuals attempted to duplicate the indication and thereby obtain certification fraudulently.

Finally, it will be appreciated that the method could be implemented by hand. However, this would not feasibly allow the benchmarks to be calculated and nor would it allow the certification to be provided in an automated fashion.

Persons skilled in the art will appreciate that numerous variations and modifications will become apparent. All such variations and modifications which become apparent to persons skilled in the art, should be considered to fall within the spirit and scope that the invention broadly appearing before described.

[image]

[image]

[image]

[image]

[image]

[image]

[image]

[image]

[image]

The claims defining the invention are as follows:

1) A method of assessing the sustainability performance of an entity, the method including:
a) Monitoring the operation of the entity;
b) Determining one or more sustainability indicators, each sustainability indicator being a respective value determined based on the operation of the entity;
c) Comparing one or more of the sustainability indicators to respective thresholds; and,
d) Generating an indication of the sustainability performance in accordance with the results of the comparison.

2) A method according to claim 1, at least one of the sustainability indicators including one or more component values, the sustainability indicator being determined based on a weighted sum of the component values.

3) A method according to claim 1 or claim 2, the sustainability indicators including at least one of:
a) An energy indicator representing the amount of energy used by the entity;
b) A water indicator representing the amount of water used by the entity; and,
c) A waste indicator representing the amount of waste generated by the entity.

4) A method according to claim 3, when dependent on claim 2, the energy indicator being formed from one or more energy component values, each energy component value representing the amount of energy used from a respective energy source.

5) A method according to claim 4, the method of determining the energy indicator including:
a) Determining a respective energy component based on the amount of energy used from a respective source;
b) Multiplying each energy component by a respective parameter to determine a respective modified component, each parameter being predetermined in accordance with the respective energy source; and,
c) Summing each of the modified energy components.

6) A method according to any one of claims 1 to 4, the sustainability indicators including at least one of:
a) A social commitment indicator representing the impact of the entity on the local community;
b) A resource conservation indicator representing the amount of ecological products used; and,
c) A chemical indicator representing the amount of chemicals used.

7) A method according to claim 6, the social commitment indicator being a ratio of the number of employees living within a predetermined distance of the entity to the total number of employees.

8) A method according to claim 6 or claim 7, the resource conservation indicator being a ratio of the number of ecolabel products used to the total number of products used.

9) A method according to any one of claims 6 to 8, the chemical indicator being a ratio of the amount of biodegradable chemicals used to the amount of chemicals used.

10) A method according to any one of claims 1 to 9, the sustainability indicators including at least the presence and implementation of an environmental policy.

11) A method according to any one of claims 1 to 10, wherein in response to a successful comparison, the method further includes:
a) Comparing one or more of the sustainability indicators to respective second thresholds; and,
b) Generating a further indication of the sustainability performance in accordance with the results of the second comparison.

12) A method according to any of claims 1 to 11, the method including:
a) Comparing each indicator to a respective threshold; and,
b) Determining that the entity satisfies minimum requirements in response to a successful comparison for each indicator.

13) A method according to claim 12, the method further including certifying the entity in response to a successful determination.

14) A method according to at least claim 10, the method including:
a) Comparing each indicator to a respective second threshold; and,
b) Determining that the entity satisfies best practice requirements in response to a successful second comparison for each indicator.

15) A method according to any of claims 1 to 14, each threshold being determined in accordance with at least one of:
a) The entity's location; and,
b) The nature of the entity's operation.

16) A method according to any one of claims 1 to 15, each threshold being determined in accordance with an average of the respective sustainability indicators determined for a sample number of entities.

17) A method according to claim 16, the threshold being 5% higher than the average of the respective sustainability indicators.

18) A method according to claim 16 or claim 17, when dependent on claim 10, the second threshold being 30% higher than the average of the respective sustainability indicators.

19) A method according to any one of the claims 1 to 18, the monitoring of the entity being performed by the entity or a member of the entity.

20) A method according to any one of the claims 1 to 19, the monitoring of the entity being performed by an accredited individual.

21) A method according to any one of the claims 1 to 20, the method further including generating a report, the report indicating the sustainability performance of the entity by indicating at least the results of the comparisons.

22) A method according to claim 21, the report further indicating improvements that could be made to the operation to thereby the sustainability performance of the entity.

23) A method according to any of claims 1 to 22, the method being performed using a processing system including at least:
a) An input for receiving the one or more sustainability indicators;
b) A store for storing the respective thresholds; and,
c) A processor, the processor being adapted to:
i) Compare the one or more of the sustainability indicators to respective thresholds; and,
ii) Generate the indication of the sustainability performance in accordance with the results of the comparison.

24) A method according to claim 23, the method further including causing the processor to store entity data in the store, the entity data representing at least:
a) The identity of the entity;
b) The sustainability indicators.

25) A method according to claim 24, the entity data further representing at least:
a) The location of the entity; and,
b) The nature of the entity's operation.

26) A method according to claim 24 or claim 25, the method including determining the thresholds in accordance with the entity data stored in the store.

27) A method of assessing the sustainability performance of an entity, the method being substantially a hereinbefore described.

28) A system for assessing the sustainability performance of an entity, the system including:
a) An input for receiving one or more sustainability indicators, each sustainability indicator being a respective value determined based on the operation of the entity;
b) A store for storing respective thresholds; and,
c) A processor, the processor being adapted to:
i) Compare the one or more of the sustainability indicators to the respective thresholds; and,
ii) Generate the indication of the sustainability performance in accordance with the results of the comparison.

29) A system according to claim 28, the input being formed from a remote processing system coupled to the system via a communications network.

30) A system according to claim 28 or claim 29, the system being formed from a number of interconnected processing systems.

31) A system according to any of claims 28 to 30, the system being adapted to perform the method of any of claims 1 to 27.

32) A system for assessing the sustainability performance of an entity, the system being substantially as hereinbefore described.

33) A computer program product for assessing the sustainability performance of an entity, the computer program product including computer executable code which when executed by a suitably programmed processor causes the processor to perform the method of any of claims 1 to 27.

34) A computer program product for assessing the sustainability performance of an entity, the computer program product being substantially as hereinbefore described.
